(19) United States
(12) Patent Application Publication
(10) Pub. No.: US 2014/0096859 A1
(43) Pub. Date: Apr. 10, 2014

(54) Muffler insulator for motocycles

(71) Applicants: Darrick C. Melton, Joliet, IL (US); Amy L. Melton, Joliet, IL (US)

(72) Inventors: Darrick C. Melton, Joliet, IL (US); Amy L. Melton, Joliet, IL (US)

(21) Appl. No.: 13/573,851

(22) Filed: Oct. 6, 2012

(51) Int. Cl. F16L 59/08

(52) U.S. Cl. CPC F16L 59/08
USPC 138/149

(57) ABSTRACT

An insulator for a motorcycle muffler having an insulating blanket, copper tubes attached to an inner surface of the insulating blanket, an outer decorative cover attached to the insulating blanket, and a means for attaching the insulator to a motorcycle muffler.

### CROSS REFERENCE TO RELATED APPLICATION

This continuation-in-part application claims the benefit of provisional application 61/203,946 filed Dec. 31, 2008 and utility application Ser. No. 12/655,412 filed Dec. 29, 2009.

### BACKGROUND

1. Field of the Invention

This application pertains to motorcycle muffler insulators designed to protect from heat emitted by motorcycle exhaust pipes.

2. Prior Art

Motorcycle exhaust pipes become dangerously hot after a motorcycle engine has been running for a period of time, causing the risk of severe burns to any person who comes in contact with the muffler. A person, especially a rider, would have to rely on protective clothing or a means to cover the muffler to protect body parts from bums.

Many riders prefer not to wear protective clothing such as leather jackets, pants and boots, particularly in warm weather. Furthermore the hot muffler remains exposed for a non-rider to come in contact with it.

Various devices have been designed to deflect hot air from the exhaust pipe. Most use air flow provided by the speed of the motorcycle to deflect the air. U.S. Pat. No. 5,036,947 to Metzger has a metal shield which uses spacers to attach a metal shield to the exhaust pipe. This device deflects hot air from the rider. However the device is dependent on air flow to operate. If the motorcycle stops moving, the exhaust pipe gets hotter, because the device does not absorb heat. Furthermore, the use of this object is limited to motorcycles which are equipped with cylindrical shaped exhaust pipes. Many motorcycles, especially high-powered sports motorcycles, have elliptical shaped exhaust pipes.

Staudt (US 2010/0035078) has a heat/acoustic shield with an inner and outer layer of hand wrapped metal material, such as aluminum or stainless steel, with a middle layer of insulation material. The outer and inner layers have embossed patterns of undulating peaks and valleys offset from one another. The undulating peaks and valleys serve to further reduce the sound of the motorcycle engine.

US 2009/0113593 to Mastronardi is a skin protector for a person exposed to a heat source such as motorcycle riders. The device is designed to be wrapped around a portion of the human body such as a leg. The protective portion of the skin protector is composed of a heat resistant fabric.

A need exists in the art for a muffler insulator that not only protects a rider from radiant and conductive heat, but also protects the motorcycle muffler from road debris, rocks and weather hazards. A need also exists in the art to provide a muffler insulator that does not further diminish to sound of the motorcycle engine.

### SUMMARY

An object of the invention is to provide a flexible insulator for a motorcycle muffler that overcomes disadvantages of the current means to protect riders from the heat of the muffler.

Another object of the invention is to provide a muffler insulator that does not reduce the sound of the motorcycle engine. Current insulators further muffle the sound of the engine. Most riders prefer the roar of their engines to be heard. Harley Davidson spent several years trying to trademark the sound of its engines. Also muffling the sound usual impedes engine performance.

Another object of the invention is to provide a muffler insulator which protects the motorcycle muffler from road debris, rocks and weather hazards.

The present invention is an insulator for a motorcycle muffler having an insulating blanket, copper tubes attached to an inner surface of the insulating blanket, an outer decorative cover attached to the insulating blanket, and a means for attaching the insulator to a motorcycle muffler.

### DRAWINGS

The invention together with the above and other objects and advantages will be best understood from the following detailed description of the preferred embodiment of the invention shown in the accompanying drawings, wherein:

FIG. 1 is a flat view of the invention.

FIG. 2 is a side view of a typical motorcycle muffler.

FIG. 3 is a cross-sectional view of a muffler covered by the invention.

FIG. 4 is an end view of a muffler covered by the invention.

### DETAILED DESCRIPTION

The following detailed description of embodiments of the present invention will be better understood when read in conjunction with the drawings.

As used herein, an element or step recited in the singular and proceeded with “a” or “an” should be understood as not excluding plural elements or steps unless such exclusion is explicitly stated. References to one embodiment of the present invention are not intended to be interpreted as excluding additional embodiments that also incorporate the recited features.

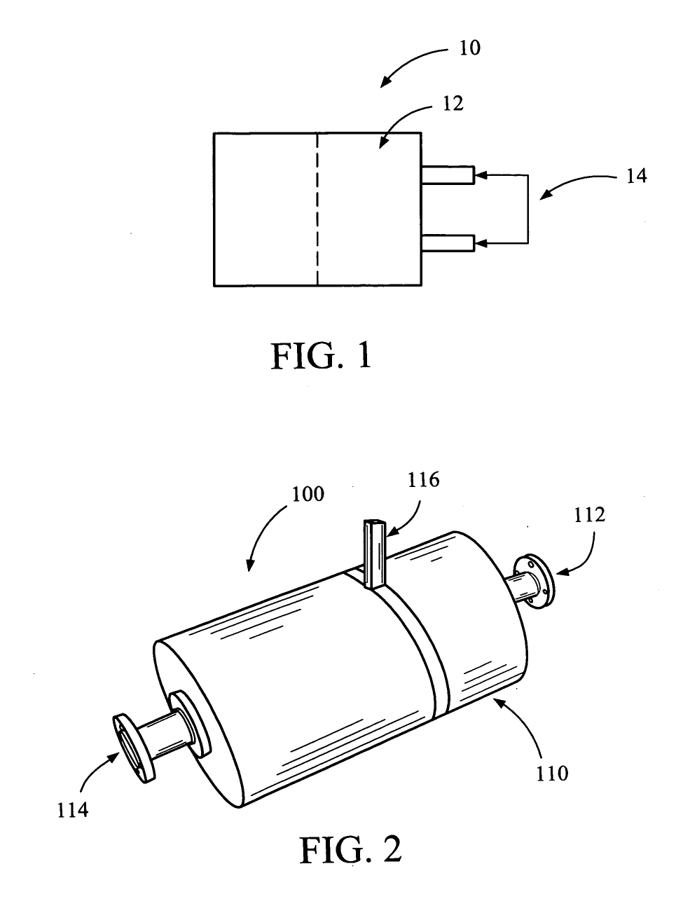

FIG. 1 shows the invention 10 in a flat position. The inner layer 12 is an insulation blanket that absorbs heat radiated from the motorcycle muffler. The blanket can be made of flexible woven, single continuous filament amorphous silica yarn, carbon fiber, or mechanically bonded glass fiber or combinations thereof. The muffler insulator is attached to the muffler by means of attachment 14. The means for attachment 14 can be hook and loop fasteners, buckles, straps, thermal tape, adjustable brackets or combinations thereof.

FIG. 2 represents a typical motorcycle muffler 100 having a housing 110 and internal baffles (not shown) for sound suppression. The inlet 112 attaches to the exhaust pipe from the engine (not shown). An outlet 114 attaches the muffle to the exhaust pipe (not shown). Muffler 100 is attached to the motorcycle by support bracket 116.

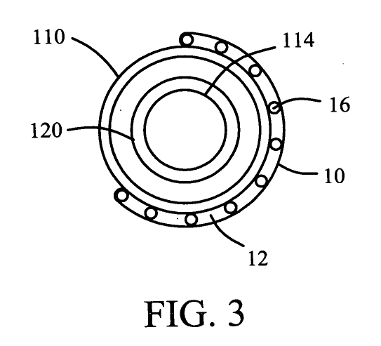

FIG. 3 shows a cross section of the motorcycle muffler 10, exhaust outlet 114 and muffler insulator 10. The muffler housing 110 contains an outlet 114 to attach the muffler to the exhaust pipe (not shown) and an inner area 120 containing baffles for noise suppression. The muffler insulator 10 is shown surrounding the muffler 100. The insulator has an insulation blanket 12 to which are attached copper tubes 16. The copper tubes are positioned between the insulation blanket 12 and the muffler housing 110. Not shown is the decorative cover which would be attached to the outer surface of the insulation blanket 12.

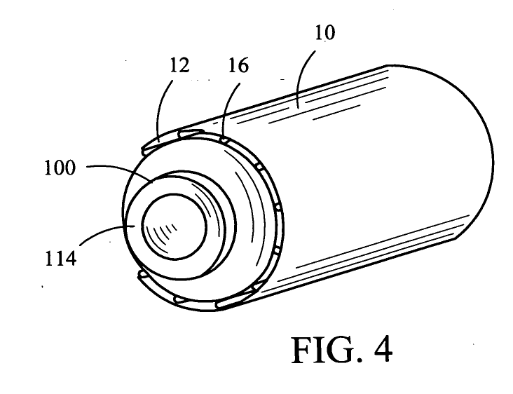

FIG. 4 shows an end view of the muffle 100 covered by the muffler insulator 10. The outlet 114 is shown protruding from the muffler 100. The insulator blanket 12 is shown covering the muffler 100 and the copper tubes 16.

Different models of motorcycles have different temperatures of exhaust gases. The speed of the engine, measured in RPM, also changes the temperature of the exhaust gas as the speed increases. At idle speed, the speed of the engine when the motorcycle is not in motion i.e. 600-1000 RPM, the average range of exhaust gas temperatures is between 760° and 850° F. For high speed motion, between 6000-10000 RPM, the average temperature range is between 1200° to 1550° F. The insulation blanket 12 of the present invention has a 2000° F. thermal rating.

Different models of motorcycles have different sizes and shapes of mufflers. Standard mufflers are generally 14 to 26 inches in length, cylindrical or oval in shape, and 6 to 12 inches in diameter. “Stubby” mufflers are generally 6 to 10 inches long, cylindrical or trapezoidal in shape and 5 to 10 inches in diameter. Due to the flexible, easily cut material used, the present invention can be adapted to fit a wide variety of motorcycle mufflers.

The present muffler insulator 10 has an insulation blanket 12 made from flexible woven, single continuous filament amorphous silica yarn, carbon fiber, or mechanically bonded glass fiber or combinations thereof. The insulator blanket 12 is the length of the muffler 100 to be covered, 0.108 to 0.216 inches thick, and slightly wider than the muffler to allow an overlapping edge. Copper tubes 16 of approximately the length of the insulating blanket 12 are attached to the inner surface of the blanket. The copper tubes, having an outer diameter of between ¼ to ¾ of an inch, are spaced 1 to 2 inches apart horizontally along the length of the insulator blanket 12. The copper tubes are attached to the insulator blanket by thermal resistant tape, thermal resistant glue, or by sewing. A slit is cut in the overlap of the insulator blanket 12 to accommodate the muffler bracket 116. A decorative outer layer is attached to the outer side if the insulator blanket 12. The decorative layer may be made of woven cloth, vinyl, or neoprene. Stain resistant material is preferred. The layers on the muffler insulator 10 are joined together by thermal resistant tape, thermal resistant glue or sewing the layers.

The muffler insulator 10 is wrapped around the muffler 100 with the overlap slit passing around the muffler bracket 116. The muffler insulator is held in place by a means for attaching the two edges. The means for attachment 14 can be hook and loop fasteners, buckles, straps, thermal tape, adjustable brackets or combinations thereof.

The muffler insulator 10 protects the muffler 100 from debris, rocks and weather hazards. The copper tubes 16 provide protection in addition to the insulating blanket 12 by providing a rigid frame.

Surprisingly and unexpectedly, the copper tubes appear to prevent the muffler insulator from further suppressing the engine noise. Sound quality and volume are important to motorcycle riders. Harley Davidson tried to trademark their distinctive engine sound. Many web sites contain information on removing the noise baffles in mufflers.

It is to be understood that the above description is intended to be illustrative, and not restrictive. The above described embodiments may be used in combination with each other. In addition many modifications may be made to adapt a particular situation or material to the teachings of the invention without departing from its scope. While the dimensions and types of the materials described herein are intended to define the parameters of the invention, they are by no means limiting, but merely exemplary embodiments. Many other embodiments will be apparent to those skilled in the art upon reviewing the above description.

The embodiment of the invention in which an exclusive property or privilege is claimed is as follows:

1. An insulator for a motorcycle muffler comprising:
a) an insulator blanket;
b) copper tubes attached to an inner surface of the insulator blanket;
c) a decorative cover attached to an outer surface of the insulator blanket; and
d) a means to attach the insulator to a motorcycle muffler.

2. The insulator of claim 1 wherein the insulator blanket is selected from the group consisting of flexible woven, single continuous filament amorphous silica yams, carbon fibers, mechanically bonded glass fibers of combinations thereof.

3. The insulator of claim 1 wherein the insulation blanket has a thermal rating of 2000° F.

4. The insulator of claim 1 wherein the insulator blanket is between 1.108 and 0.218 inches thick.

5. The insulator of claim 1 where in insulator length is the length of the motorcycle muffler to be insulated.

6. The insulator of claim 1 wherein the insulator is wider than the width of the motorcycle muffler to be insulated.

7. The insulator of claim 1 wherein the copper tubes are attached to the inner surface of the insulator blanket by thermal resistant tape, thermal resistant glue, sewing or combinations thereof.

8. The insulator of claim 1 wherein the copper tubes have an outer diameter of between ¼ to ¾ inches.

9. The insulator of claim 1 wherein the copper tubes are attached 1 to 2 inches apart, horizontally along the inner surface of the insulator blanket.

10. The insulator of claim 1 wherein the copper tubes are approximately the length of the insulator blanket.

11. The insulator of claim 1 wherein the decorative cover is selected form the group consisting of woven cloth, vinyl, or neoprene.

12. The insulator of claim 1 wherein the decorative cover is approximately the length of the insulator blanket.

13. The insulator of claim 1 wherein the decorative cover is stain resistant.

14. The insulator of claim 1 wherein the insulator blanket and decorative cover are joined together by thermal resistant tape, thermal resistant glue or stitches.

15. The insulator of claim 1 wherein the means to attach the insulator to the muffler is selected from the group consisting of hook and loop fasteners, buckles, straps, thermal tape, adjustable brackets or combinations thereof.
